(19) United States
(12) Patent Application Publication
(10) Pub. No.: US 2010/0033484 A1
(43) Pub. Date: Feb. 11, 2010

(54) PERSONAL-ORIENTED MULTIMEDIA STUDIO PLATFORM APPARATUS AND METHOD FOR AUTHORIZATION 3D CONTENT

(76) Inventors: Nac-Woo Kim, Seoul (KR); Woontack Woo, Gwangju-City (KR); Bong-Tae Kim, Daejeon (KR); Byung-Tak Lee, Suwon (KR); Ho-Young Song, Daejeon (KR); Wonwoo Lee, Gwangjoo-City (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/517,475

(22) PCT Filed: Nov. 21, 2007
(86) PCT No.: PCT/KR07/05849

§ 371 Date: Jun. 3, 2009

(30) Foreign Application Priority Data
Dec. 5, 2006 (KR) 10-2006-0122607
Oct. 4, 2007 (KR) 10-2007-0099926

(51) Int. Cl. G06T 15/50; G09G 5/00; G06F 3/038

(52) U.S. Cl. 345/426; 345/582; 345/213

(57) ABSTRACT

There is provided a personal-oriented multimedia studio platform apparatus. A plurality of users to share multi-media objects by providing a function of authoring 3-Dimensional (3D) objects using a common-use camera instead of expensive mechanism for acquiring a 3D image, providing robust interaction with a user by means of augmented reality implementation and an automatic user motion extraction function, and allowing a user to receive a content object from a remote server.

### TECHNICAL FIELD

The present invention relates to a personal-oriented multimedia studio platform apparatus, and more particularly, to a personal-oriented multimedia studio platform apparatus for allowing individuals to easily authoring/editing/transmitting various types of multimedia by means of a Personal Computer (PC) or a Set-Top Box (STB).

This application claims the benefit of Korean Patent Application No. 10-2006-0122607, filed on Dec. 5, 2006, in the Korean Intellectual Property Office, the disclosure of which is incorporated herein in its entirety by reference.

### BACKGROUND ART

A new trend of recent Internet is gradually emphasizing the importance of prosumers according to transition from a multimedia environment oriented to a small number of suppliers to a media environment oriented to a large number of authors.

In general, conventional multimedia studio platform apparatuses provide a function of authoring/editing 2-Dimensional (2D) moving pictures or a function of creating 3D objects and extracting/editing user objects using an expensive mechanism.

In addition, in order to use an authoring apparatus provided by the conventional multimedia studio platform apparatuses, advanced expertise is required, and it is necessary to buy expensive software/hardware, and thus, it is almost impossible for general users to easily produce user content using any of these apparatuses.

### DISCLOSURE OF INVENTION

### Technical Problem

In general, conventional multimedia studio platform apparatuses provide a function of authoring/editing 2-Dimensional (2D) moving pictures or a function of creating 3D objects and extracting/editing user objects using an expensive mechanism.

In addition, in order to use an authoring apparatus provided by the conventional multimedia studio platform apparatuses, advanced expertise is required, and it is necessary to buy expensive software/hardware, and thus, it is almost impossible for general users to easily produce user content using any of these apparatuses.

### Technical Solution

The present invention provides a method of creating personal-oriented multimedia content so as for a plurality of users to share multimedia objects by providing a function of authoring 3-Dimensional (3D) objects using a common-use camera instead of expensive mechanism for acquiring a 3D image, providing robust interaction with a user by means of augmented reality implementation and an automatic user motion extraction function, and allowing a user to receive a content object from a remote server.

The objectives and merits of the present invention will be understood from the description below and be more obvious by means of embodiments of the present invention. In addition, it will be easily known that the objectives and merits of the present invention can be implemented by means of measures and their combination shown in claims.

### ADVANTAGEOUS EFFECTS

The present invention can cultivate prosumers being raised as the core of multimedia generation, develop personal media industry, and be applied to various application fields, such as Small Office Home Office (SOHO), by providing a simple User Created Content (UCC) production environment without using a difficult and expensive multimedia software producing/editing equipment, such as MAYA, 3DMAX, Adobe Premiere.

Since the present invention is implemented as a server/client model, by storing major content objects in a server of a content provider and sharing the objects with a plurality of users, even if the content provider does not directly produce content objects, many people can use or consume various content objects at the same time.

Furthermore, 2D multimedia objects and 2.5D/3D objects can be generated and created, a user interaction can be performed by automatically extracting a moving object and implementing AR, and a more realistic image, and realistic content can be generated by using a rendering scheme by means of simple light source estimation.

Thus, according to the present invention, users can use or produce 3D content based on various types of software with a low cost.

### DESCRIPTION OF DRAWINGS

The above and other features and advantages of the present invention will become more apparent by describing in detail exemplary embodiments thereof with reference to the attached drawings in which:

FIG. 1 illustrates a personal-oriented multimedia studio platform for generating personal-oriented multimedia content in a network according to an embodiment of the present invention;

FIG. 2 is a block diagram of the personal-oriented multimedia studio platform illustrated in FIG. 1, according to an embodiment of the present invention;

FIG. 3 is a signaling diagram of a data flow between server and client multimedia transmission platforms of the personal-oriented multimedia studio platform illustrated in FIG. 1, according to an embodiment of the present invention;

FIG. 4 is a block diagram of a 3-Dimensional (3D) content authoring platform according to an embodiment of the present invention;

FIG. 5 is a block diagram of a 3D virtual studio platform according to an embodiment of the present invention;

FIG. 6 is a flowchart illustrating a multimedia content object generation method of a 3D content authoring platform, according to an embodiment of the present invention; and

FIG. 7 is a flowchart illustrating a multimedia content generation and editing method of a 3D virtual studio platform, according to an embodiment of the present invention.

### BEST MODE

According to an aspect of the present invention, there is provided a 3-Dimensional (3D) virtual studio platform apparatus of a client server, the apparatus comprising: a user object extractor recognizing and extracting a user object from an input 2-Dimensional (2D) image by means of background learning of the input 2D image; an Augmented Reality (AR) unit generating an AR-implemented user object by recognizing an AR marker from the user object and overlapping an AR virtual object received from a content provider server on the AR marker; an image mixer rendering the AR-implemented user object, a 2.5D background model received from the content provider server, a light source estimated based on an image used to generate the 2.5D background model, and a 3D object model for each frame according to time; and an object adjuster adjusting positions of the AR-implemented user object, the 2.5D background model, the 3D object model, and the estimated light source in the image mixer according to time.

According to another aspect of the present invention, there is provided a 3-Dimensional (3D) content authoring platform apparatus of a content provider server, the apparatus comprising: a 2.5D background model generator matching a plurality of multiview images acquired from a multiview camera and generating a 2.5D background model from 3D point data generated by means of the matching; a 3D object model generator generating a 3D object model by reconfiguring a plurality of 2D images acquired from a 2D camera to a 3D image and performing texture mapping with respect to the reconfigured 3D image; a 3D virtual object generator generating a virtual object so that a client can implement Augmented Reality (AR); and a light source estimator estimating a light source of the plurality of images acquired by the multiview camera using the 3D point data and texture values.

According to another aspect of the present invention, there is provided a personal-oriented multimedia studio platform apparatus comprising: a 3-Dimensional (3D) content authoring platform generating a 2.5D background model; a 3D object model, a light source estimated based on an image used to generate the 2.5D background model, and a content object of an Augmented Reality (AR)-implemented model providing a user interactive environment, which are used for producing multimedia content by a user; and a 3D virtual studio platform receiving the content object and generating and editing personal-oriented multimedia content by means of mixing a real-time split image of a 2D user image acquired from a 2D camera and the content object.

According to another aspect of the present invention, there is provided a personal-oriented multimedia content generation method of a 3-Dimensional (3D) virtual studio platform apparatus, the method comprising: recognizing and extracting a user object from an input 2D image by means of background learning of the input 2D image; generating an Augmented Reality (AR)-implemented user object by recognizing an AR marker from the extracted user object and overlapping an AR virtual object received from a content provider server on the AR marker; adjusting positions of the AR-implemented user object, a 2.5D background model received from the content provider server, a 3D object model, and a light source estimated based on an image used to generate the 2.5D background model according to time; and rendering the AR-implemented user object, the 2.5D background model, the estimated light source, and the 3D object model for each frame according to the adjusted time.

According to another aspect of the present invention, there is provided a multimedia content generation method of a 3-Dimensional (3D) content authoring platform apparatus, the method comprising: matching a plurality of multiview images acquired from a multiview camera and generating a 2.5D background model from 3D point data generated by means of the matching; estimating a light source of the plurality of images acquired by the multiview camera using the 3D point data and texture values; generating a 3D object model by reconfiguring a plurality of 2D images acquired from a 2D camera to a 3D image and performing texture mapping with respect to the reconfigured 3D image; and generating a virtual object so that a client can implement Augmented Reality (AR).

A computer readable recording medium storing a computer readable program for executing a personal-oriented multimedia content generation method of a 3-Dimensional (3D) virtual studio platform apparatus and a multimedia content generation method of a 3D content authoring platform apparatus.

### MODE FOR INVENTION

The present invention will be described in detail by explaining embodiments of the invention with reference to the attached drawings. Like reference numbers are used to refer to like elements through at the drawings. In the following description, well-known functions or constructions are not described in detail since they would obscure the invention with unnecessary detail.

In addition, when a part ‘includes’ or ‘comprises’ a certain component, this means that the part does not exclude other components unless there is specific description and can further include other components.

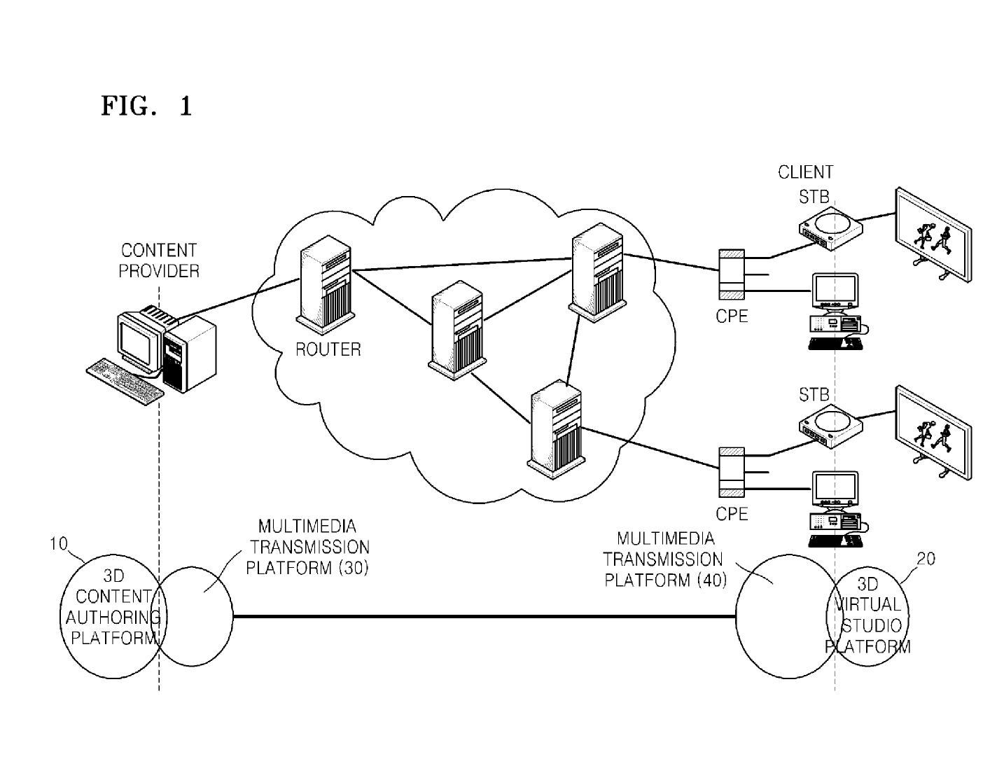

FIG. 1 illustrates a personal-oriented multimedia studio platform for generating personal-oriented multimedia content in a network according to an embodiment of the present invention.

Referring to FIG. 1, the personal-oriented multimedia studio platform according to an embodiment of the present invention is a multimedia content generation apparatus and includes a 3-Dimensional (3D) content authoring platform 10, a 3D virtual studio platform 20, and multimedia transmission platforms 30 and 40.

The 3D content authoring platform 10 is a multimedia content object generation apparatus included in a server of a content provider. The 3D content authoring platform 10 generates content objects used for producing multimedia content by a user, such as a 2.5D background model, an estimated light source, a 3D object model, and an Augmented Reality (AR)-implemented model, by means of a 2D/3D camera. The 3D content authoring platform 10 transmits the generated content objects to the 3D virtual studio platform 20 via the multimedia transmission platform 30.

The 3D virtual studio platform 20 is a multimedia content generation and editing apparatus included in a Personal Computer (PC) or a Set-Top Box (STB), which is a Customer Premises Equipment (CPE) of a client. The 3D virtual studio platform 20 dynamically generates and edits personalized multimedia content by mixing the 2.5D background model, the estimated light source, the 3D object model, and the AR-implemented model received from the 3D content authoring platform 10 via the multimedia transmission platform 40 together with a 2D user object extraction image.

A client terminal equips a virtual terminal device for a remote access from the 3D virtual studio platform 20 to the 3D content authoring platform 10 and a software program for enabling data transmission by means of the remote access from the 3D virtual studio platform 20 to the 3D content authoring platform 10.

The multimedia transmission platform 30 is a data transmitter for transmitting the 2.5D background model, the estimated light source, the 3D object model, and the AR-implemented model of the 3D content authoring platform 10 when receiving a data transmission request from the 3D virtual studio platform 20.

The multimedia transmission platform 40 is a data receiver for receiving the 2.5D background model, the estimated light source, the 3D object model, and the AR-implemented model that are to be used for image mixing in the 3D virtual studio platform 20 from the 3D content authoring platform 10.

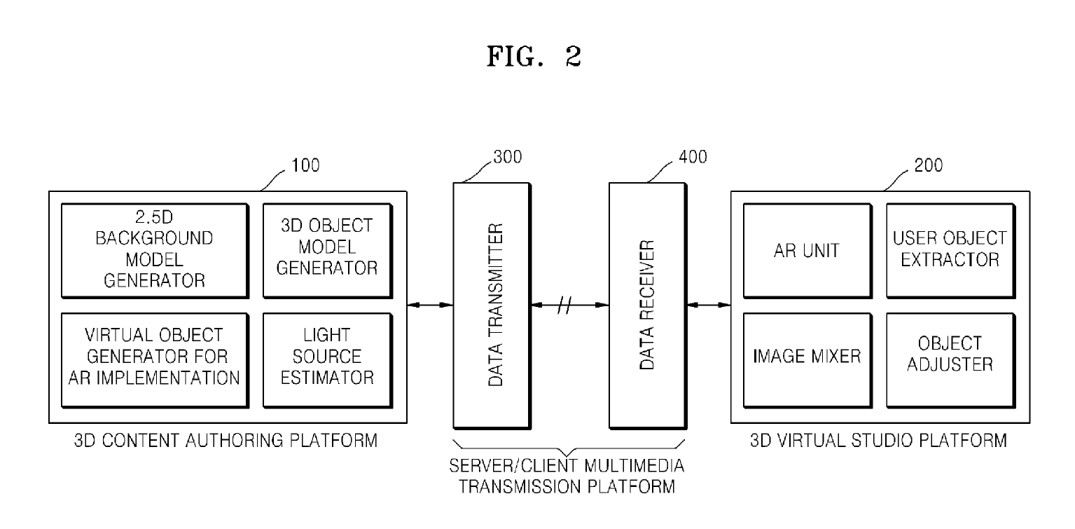

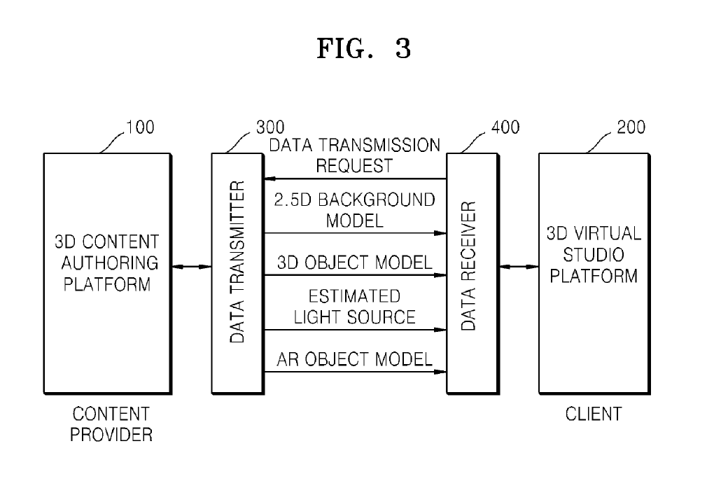

FIG. 2 is a block diagram of the personal-oriented multimedia studio platform illustrated in FIG. 1, according to an embodiment of the present invention, and FIG. 3 is a signaling diagram of a data flow between server and client multimedia transmission platforms of the personal-oriented multimedia studio platform illustrated in FIG. 1, according to an embodiment of the present invention.

Referring to FIG. 2, the personal-oriented multimedia studio platform includes a 3D content authoring platform 100, a 3D virtual studio platform 200, and server and client multimedia transmission platforms 300 and 400.

The 3D content authoring platform 100 generates a 2.5D background model, a 3D object model, an estimated light source point, and an AR-implemented model for providing a user interactive environment. To do this, the 3D content authoring platform 100 includes a content object generator, which includes a 2.5D background model generator, a 3D object model generator, a 3D virtual object generator, and an light source estimator, as a major component.

The 3D virtual studio platform 200 receives an authored multimedia content object from the 3D content authoring platform 100 and real-time generates and edits new multimedia content by mixing a real-time split image of a user, which is input from a 2D camera, and the received multimedia content object. To do this, the 3D virtual studio platform 200 includes a multimedia content generator, which includes a user object extractor, an AR unit, an image mixer, and an object adjuster, as a major component.

The internal configurations of the 3D content authoring platform 100 and the 3D virtual studio platform 200 will be described later.

The server and client multimedia transmission platforms 300 and 400 are server and client multimedia data transmission platforms for object linking between the 3D content authoring platform 100 and the 3D virtual studio platform 200.

Referring to FIG. 3, the server multimedia transmission platform 300 includes a data transmitter for transmitting the 2.5D background model, the 3D object model, the AR virtual object model, and the estimated light source point of the 3D content authoring platform 100 to the 3D virtual studio platform 200 when receiving a data transmission request from the 3D virtual studio platform 200.

The client multimedia transmission platform 400 includes a data receiver for transmitting a data transmission request to the 3Dcontent authoring platform 100 and receiving the 2.5D background model, the 3D object model, the AR virtual object model, and the estimated light source that are to be used for image mixing in the 3D virtual studio platform 200 from the 3Dcontent authoring platform 100.

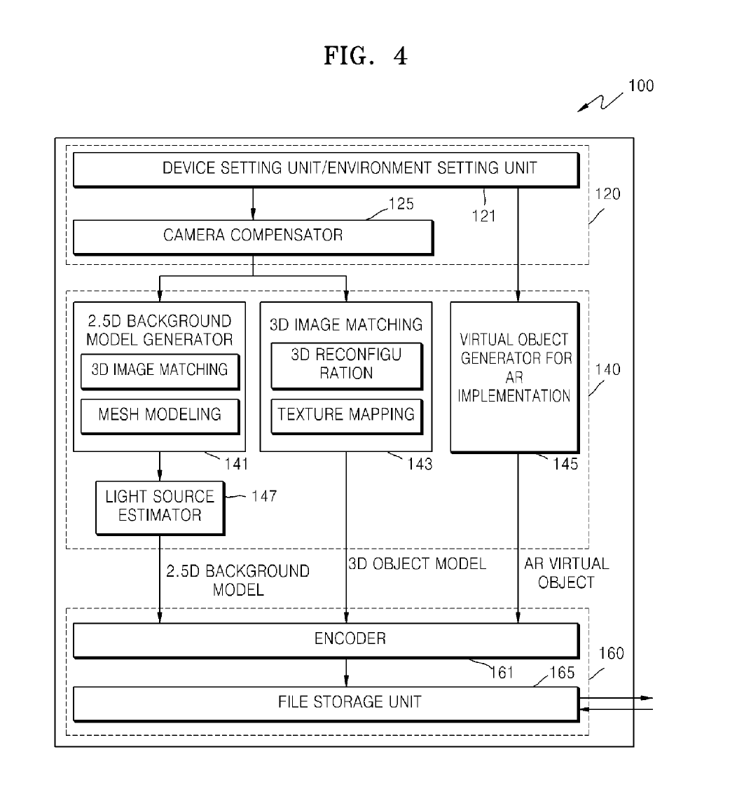

FIG. 4 is a block diagram of the 3D content authoring platform 100 according to an embodiment of the present invention.

Referring to FIG. 4, the 3D content authoring platform 100 includes a peripheral device 120, a content object generator 140, and a storage device 160.

The peripheral device 120 includes a device/environment setting unit 121 and a camera compensator 125.

The device/environment setting unit 121 sets an image/voice input device and sets various kinds of parameters of the image/voice input device.

The camera compensator 125 estimates camera internal/external parameters based on an image acquired from a multiview or 2D camera. That is, the camera compensator 125 extracts feature points between multiview images or 2D images, which are acquired at different times, optimizes homography between continuous images by matching the extracted feature points, and estimates a camera pose with respect to the continuous images.

The content object generator 140 includes a 2.5D background model generator 141, a 3D object model generator 143, a 3D virtual object generator 145, and a light source estimator 147.

The 2.5D background model generator 141 matches and merges a plurality of images acquired from a multiview camera, e.g., triclops camera, using the camera parameters input from the camera compensator 125 and generates a 2.5D background model from the matched 3D point data. That is, the 2.5D background model generator 141 generates a 2.5D background model by performing matching and merging by means of projection of image data restored from multiview images acquired at different times and pose estimation data of the multiview camera and generating a mesh model from 3D point data generated by the matching and merging.

The 3D object model generator 143 generates a 3D object by reconstructing a plurality of images acquired from the 2D camera to a 3D image using the camera parameters input from the camera compensator 125 and texture mapping the 3D image. That is, the 3D object model generator 143 generates a 3D object model by reconstructing the image data restored from the plurality of images acquired at different times and the pose estimation data of the 2D camera and performing texture mapping of the reconstructed 3D image. For the image restoration, a silhouette based image restoration scheme can be used.

The 3D virtual object generator 145 generates various objects for more interesting user interaction when AR is implemented.

The light source estimator 147 traces a 3D light source position from the 3D point data and a texture value obtained from the 2.5D background model generator 141. The texture value is color data acquired from the multiview images.

The storage device 160 includes an encoder 161 and a file storage unit 165.

The encoder 161 compresses the 2.5D background model, the estimated light source, the 3D object model, and the AR virtual object data input from the content object generator 140.

The file storage unit 165 stores a compressed image input from the encoder 161, and if a data transmission request is received from the 3D virtual studio platform 200, transmits a corresponding stored compressed image to the 3D virtual studio platform 200 via the data transmitter 300.

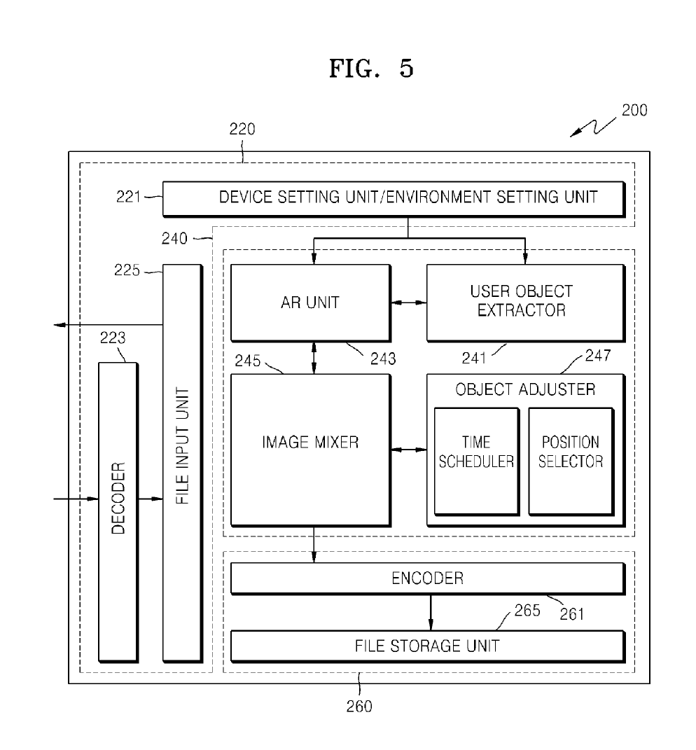

FIG. 5 is a block diagram of the 3D virtual studio platform 200 according to an embodiment of the present invention.

Referring to FIG. 5, the 3D virtual studio platform 200 includes a peripheral device 220, a multimedia content generator 240, and a storage device 260.

The peripheral device 220 includes a device/environment setting unit 221, a decoder 223, and a file input unit 225.

The device/environment setting unit 221 sets an image/voice input device and sets various kinds of parameters of the image/voice input device.

The decoder 223 decodes a compressed file received from the 3D content authoring platform 100 in a remote area and transmits the decoded file to the file input unit 225.

The file input unit 225 requests the 3D content authoring platform 100 in a remote area for a 2.5D background model, a 3D object model, an estimated light source, and an AR virtual object, receives these decoded objects via the decoder 223, and transmits the decoded objects to the multimedia content generator 240.

The multimedia content generator 240 includes a user object extractor 241, an AR unit 243, an image mixer 245, and an object adjuster 247.

The user object extractor 241 real-time recognizes and splits a user object by means of background learning using 2D images input from the outside. The user object extractor 241 learns static backgrounds for a predetermined time with respect to input 2D images and then extracts the dynamic user object.

The AR unit 243 generates realistic virtual content by recognizing an AR marker for AR implementation from the extracted user object and overlapping a virtual object onto a real image by positioning the AR virtual object received from the file input unit 223 on the AR marker. In the present invention, this generated content is called an AR-implemented user object, meaning a single multimedia object generated by overlapping a real user image with a virtual image on an AR marker by inserting a virtual object onto the AR marker when a user object and the AR marker appear simultaneously in a 2D image input from a camera.

The image mixer 245 gathers the AR-implemented user object input from the AR unit 243 and the 2.5D background model, the 3D object model, and the estimated light source input from the file input unit 223 in a virtual studio work space and renders them for each frame according to time.

The object adjuster 247 performs a time scheduling and position selection function of disposing each multimedia content object and the light source position received from the image mixer 245 in a work space and adjusting their position according to time. That is, the object adjuster 247 disposes each multimedia content object and the light source position received from the image mixer 245 in a work space, respectively designates specific positions at a current time t₀ and subsequent times t₁, t₂, . . . , tₙ for each object, and designates an object position between times using various linear/nonlinear methods.

The storage device 260 includes an encoder 261 and a file storage unit 265.

The encoder 261 generates a single compressed 2D image stream by encoding the frames rendered by the image mixer 245.

The file storage unit 265 stores an image input from the encoder 261.

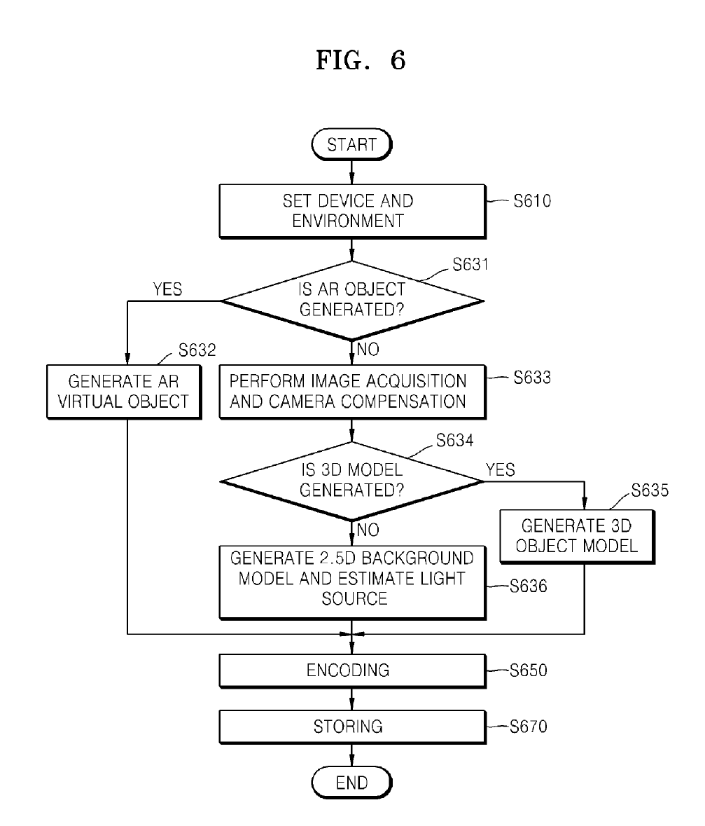

FIG. 6 is a flowchart illustrating a multimedia content object generation method of a 3D content authoring platform, according to an embodiment of the present invention.

Referring to FIG. 6, a device/environment setting unit sets devices and their environments by receiving setting values of devices and environments of a 3D content authoring server, such as an image/voice input device, in operation S610.

A content object generator generates a content object model for acquiring 3D content with respect to a plurality of images acquired according to the setting result. The object model generation process will now be described in more detail.

The 3D content authoring platform determines in operation S631 whether an AR object is generated, and if it is determined in operation S631 that an AR object is generated, a virtual object generator generates a virtual object in operation S632.

According to the setting result, a plurality of images are acquired from a multiview or common-use (2D) camera in operation S633. In this case, a camera compensator optimizes homography between continuous images by extracting and matching feature points between multiview images acquired at two different times in order to generate a 2.5D background model and performs an algorithm of estimating a camera pose with respect to the continuous images.

The 3D content authoring platform determines in operation S634 whether a 3D model is generated, if it is determined in operation S634 that a 3D model is generated, the 3D content authoring platform generates a 3D object model using a 3D object model generator in operation S635. The 3D object model generator generates a 3D object model by reconstructing data acquired to a 3D model using a silhouette based image restoration scheme and a camera compensation algorithm with respect to a plurality of images acquired from a common-use camera and performing texture mapping of the 3D model.

If it is determined in operation S634 that a 2.5D model is generated, the 3D content authoring platform generates a 2.5D background model using a 2.5D background model generator and estimates a light source in operation S636. The 2.5D background model generator generates a 2.5D background model by performing matching and merging by means of projection of color and depth data of backgrounds acquired from a multiview camera and data acquired using the camera compensation algorithm and generating a mesh model from 3D data generated by means of the matching and merging. In addition, a light source estimator estimates a light source from 3D data points and color data.

An encoder compresses the 3D data and color information generated using the 3D object model generator, the 2.5D data and color information generated using the 2.5D background model generator, and the light source information by means of a Motion Picture Experts Group 4 (MPEG4) compression model and an MPEG2-TS (Transmission Streams) transmission model in operation S650, and a file storage unit stores the compressed file in operation S670.

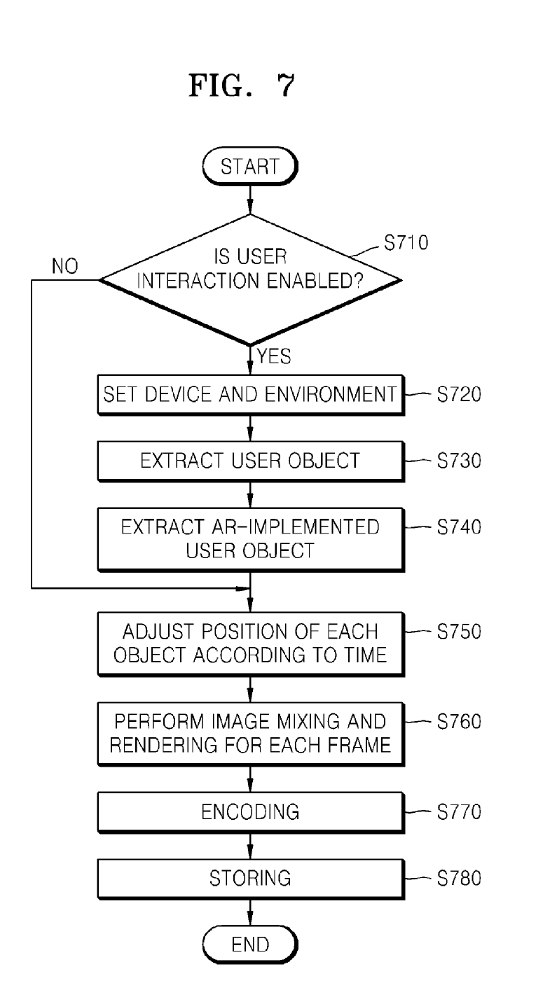

FIG. 7 is a flowchart illustrating a multimedia content generation and editing method of a 3D virtual studio platform, according to an embodiment of the present invention.

Referring to FIG. 7, the 3D virtual studio platform determines in operation S710 whether content is generated by an interaction with a user.

If it is determined in operation S710 that an interaction with the user is requested, a device/environment setting unit sets devices and their environments by receiving device and environment setting values of the 3D virtual studio platform, such as an image/voice input device, image brightness, and a volume, from the user in operation S720.

A user object extractor learns static backgrounds for a predetermined time by means of a camera input of the user and then extracts a dynamic user object in operation S730. The user inserts the extracted user object into a virtual studio work space.

When a real user object has an AR marker for AR virtual object insertion on a hand or a body, if the user inserts an AR virtual object received from the 3D content authoring platform onto the AR marker, an AR unit generates realistic virtual content in operation S740. In this case, the user reads the 2.5D background model, the 3D object model, and the estimated light source received from the 3D content authoring platform to the virtual studio work space.

An object adjuster adjusts an initial position of each object and performs position scheduling according to time for each object in operation S750.

An image mixer renders each object in the virtual studio work space for each frame according to time in operation S760.

An encoder generates a single compressed 2D image stream by encoding the rendered frames in operation S770, and a file storage unit stores an image file in operation S780.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A 3-Dimensional (3D) virtual studio platform apparatus of a client server, the apparatus comprising:
a user object extractor recognizing and extracting a user object from an input 2-Dimensional (2D) image by means of background learning of the input 2D image;
an Augmented Reality (AR) unit generating an AR-implemented user object by recognizing an AR marker from the user object and overlapping an AR virtual object received from a content provider server on the AR marker;
an image mixer rendering the AR-implemented user object, a 2.5D background model received from the content provider server, a light source estimated based on an image used to generate the 2.5D background model, and a 3D object model for each frame according to time; and
an object adjuster adjusting positions of the AR-implemented user object, the 2.5D background model, the 3D object model, and the estimated light source in the image mixer according to time.

2. The apparatus of claim 1, wherein the user object extractor extracts a dynamic user object after learning static backgrounds for a predetermined time with respect to the input 2D image.

3. The apparatus of claim 1, wherein the object adjuster designates initial positions of the AR-implemented user object, the 2.5D background model, the 3D object model, and the estimated light source in the image mixer and adjusts a position of a specific time for each object according to time.

4. The apparatus of claim 3, wherein the object adjuster designates the position of a specific time for each object using a linear or nonlinear method.

5. The apparatus of claim 1, further comprising:
a device/environment setting unit setting an external image/voice input device and setting parameters of the image/voice input device;
a decoder decoding the AR virtual object, the 2.5D background model, the estimated light source, and the 3D object model; and
a file input unit transmitting the decoded AR virtual object to the AR unit and transmitting the 2.5D background model, the estimated light source, and the 3D object model to the image mixer.

6. The apparatus of claim 1, further comprising:
an encoder generating a 2D image stream by encoding each frame rendered according to time; and
a file storage unit storing the generated 2D image stream.

7. A 3-Dimensional (3D) content authoring platform apparatus of a content provider server, the apparatus comprising:
a 2.5D background model generator matching a plurality of multiview images acquired from a multiview camera and generating a 2.5D background model from 3D point data generated by means of the matching;
a 3D object model generator generating a 3D object model by reconfiguring a plurality of 2D images acquired from a 2D camera to a 3D image and performing texture mapping with respect to the reconfigured 3D image;
a 3D virtual object generator generating a virtual object so that a client can implement Augmented Reality (AR); and
a light source estimator estimating a light source of the plurality of images acquired by the multiview camera using the 3D point data and texture values.

8. The apparatus of claim 7, wherein the 2.5D background model generator generates a 2.5D background model by performing matching and merging by means of projection of image data restored from multiview images acquired at different times and pose estimation data of the multiview camera estimated from the multiview images and generating a mesh model from 3D point data generated by the matching and merging.

9. The apparatus of claim 7, wherein the texture values used for the light source estimation include color data acquired from the multiview images.

10. The apparatus of claim 7, wherein the 3D object model generator generates a 3D object model by reconfiguring image data restored from a plurality of images acquired at different times and pose estimation data of the 2D camera estimated from the plurality of images to a 3D image and performing texture mapping with respect to the reconfigured 3D image.

11. The apparatus of claim 7, further comprising:
a device/environment setting unit setting an image/voice input device and setting parameters of the image/voice input device; and
a camera compensator estimating internal/external parameters of the multiview camera and the 2D camera from the multiview images and the 2D images.

12. The apparatus of claim 11, wherein the camera compensator extracts feature points between multiview images or 2D images, which are acquired at different times, optimizes homography between continuous images by matching the extracted feature points, and estimates a camera pose with respect to the continuous images.

13. The apparatus of claim 7, further comprising:
an encoder generating a compressed image by encoding the 2.5D background model, the estimated light source, the 3D object model, and the AR virtual object data; and
a file storage unit storing the compressed image.

14. A personal-oriented multimedia content generation method of a 3-Dimensional (3D) virtual studio platform apparatus, the method comprising:
recognizing and extracting a user object from an input 2D image by means of background learning of the input 2D image;
generating an Augmented Reality (AR)-implemented user object by recognizing an AR marker from the extracted user object and overlapping an AR virtual object received from a content provider server on the AR marker;
adjusting positions of the AR-implemented user object, a 2.5D background model received from the content provider server, a 3D object model, and a light source estimated based on an image used to generate the 2.5D background model according to time; and
rendering the AR-implemented user object, the 2.5D background model, the estimated light source, and the 3D object model for each frame according to the adjusted time.

15. The method of claim 14, wherein the recognizing and extracting of the user object comprises extracting a dynamic user object after learning static backgrounds for a predetermined time with respect to the input 2D image.

16. The method of claim 14, wherein the adjusting of the positions comprises designating initial positions of the AR-implemented user object, the 2.5D background model, the 3D object model, and the estimated light source and adjusting a position of a specific time for each object according to time.

17. The apparatus of claim 14, further comprising:
setting an external image/voice input device and setting parameters of the image/voice input device before the extracting of the user object; and
decoding the AR virtual object, the 2.5D background model, the estimated light source, and the 3D object model received from the content provider server before the adjusting.

18. The apparatus of claim 14, further comprising:
generating and storing a 2D image stream by encoding each frame rendered according to time.

19. A multimedia content object generation method of a 3-Dimensional (3D) content authoring platform apparatus, the method comprising:
matching a plurality of multiview images acquired from a multiview camera and generating a 2.5D background model from 3D point data generated by means of the matching;
estimating a light source of the plurality of images acquired by the multiview camera using the 3D point data and texture values;
generating a 3D object model by reconfiguring a plurality of 2D images acquired from a 2D camera to a 3D image and performing texture mapping with respect to the reconfigured 3D image; and
generating a virtual object so that a client can implement Augmented Reality (AR).

20. The method of claim 19, wherein the generating of the 2.5D background model comprises generating a 2.5D background model by performing matching and merging by means of projection of image data restored from multiview images acquired at different times and pose estimation data of the multiview camera estimated from the multiview images and generating a mesh model from 3D point data generated by the matching and merging.

21. The method of claim 19, wherein the generating of the 3D object model comprises generating a 3D object model by reconfiguring image data restored from a plurality of images acquired at different times and pose estimation data of the 2D camera estimated from the plurality of images to a 3D image and performing texture mapping with respect to the reconfigured 3D image.

22. The method of claim 19, further comprising:
setting an image/voice input device and setting parameters of the image/voice input device before the generating of the 2.5D background model; and
estimating internal/external parameters of the multiview camera and the 2D camera from the multiview images and the 2D images.

23. The method of claim 22, wherein the estimating internal/external parameters comprises extracting feature points between multiview images or 2D images, which are acquired at different times, optimizing nomography between continuous images by matching the extracted feature points, and estimating a camera pose with respect to the continuous images.

24. The method of claim 19, further comprising generating a compressed image by encoding the 2.5D background model, the estimated light source, the 3D object model, and the AR virtual object data.
